(19) United States
(12) Patent Application Publication
(10) Pub. No.: US 2015/0078116 A1
(43) Pub. Date: Mar. 19, 2015

(54) GAS MIXING CONTROLLER AND METHOD FOR CONTROLLING MIXING RATIO IN GAS MIXING CONTROLLER

(71) Applicant: SEHWA HIGH TECH CO., LTD., Bucheon-si, Gyeonggi-do (KR)

(72) Inventor: Jong-Hyeok Kim, Yongin-si (KR)

(21) Appl. No.: 14/387,538

(22) PCT Filed: Feb. 7, 2013
(86) PCT No.: PCT/KR2013/000971

§ 371 Date: Sep. 23, 2014

(30) Foreign Application Priority Data
Mar. 26, 2012 (KR) 10-2012-0030787

(51) Int. Cl. B01F 15/02; B01F 3/02

(52) U.S. Cl. CPC B01F 15/0261; B01F 3/026
USPC 366/152.1

(57) ABSTRACT

Disclosed are a gas mixing controller and a method for controlling the mixing ratio in the gas mixing controller. The present invention comprises the process of: a gas mixing controller transmitting respective target flow values, determined according to target mixing ratios, to a plurality of mass flow controllers (MFC's) which respectively control the flows at a plurality of pipes; receiving respective actual flow values from each outlet of the plurality of pipes through the plurality of MFC's; revising target flow values for MFC's controlling the flow from the remaining pipes of the plurality of pipes which are not pipes for which the difference between the target flow value and the actual flow value does not lie outside a predetermined error range; and receiving the revised target flow values through the MFC's controlling the flow for the remaining pipes. According to the present invention, the target flow for an elemental gas is actively readjusted so as to prevent the occurrence of a mixing ratio error in the gas mixture which occurs due to an error in the flow of the elemental gas.

### TECHNICAL FIELD

The present invention relates to a gas mixing controller and a method for controlling a mixing ratio in a gas mixing controller, and more particularly, to a gas mixing controller and a method for controlling a mixing ratio in a gas mixing controller capable of preventing the occurrence of a mixing ratio error in a mixing gas caused by a flow error in an element gas by actively readjusting a target flow of the element gas.

### BACKGROUND ART

A mass flow controller (MFC) is a precision flow controller which includes a flow measurement sensor and a valve controlled by a flow value measured by the flow measurement sensor. Currently, most of the precision gas mixers control a mixing ratio by controlling a flow of an element gas using the MFC.

Generally, for the MFC to be normally operated, a pressure of an input side of the MFC should be maintained to be larger than that of an output side thereof as much as 0.5 to 2.8 bar, but a pressure in a pipe of a gas facility may be easily changed under the following conditions.

That is, when resistance components (valve, tank, or the like) in a pipe connected to a rear end of the gas mixer are increased, a pressure therein may rise, when a total flow is increased, a pressure in a rear end of the MFC may rise and a pressure in a front end thereof may drop, and when the total flow is reduced, the pressure in the rear end of the MFC may drop and the pressure in the front end thereof may rise.

In addition, when a residual quantity of a cylinder connected to an input pipe is reduced, an output pressure of a regulator is reduced and a pressure control function of the regulator is damaged, thereby causing a condition in which it is impossible to control the pressure.

As described above, the pressure in the pipe of the gas facility is changed in real time due to various factors, and therefore a manager should perform appropriate operations to cope with the change. However, when the manager fails to perform the appropriate operations and thus the pressure condition is not satisfied, a difference between a target flow and an actual flow of an element gas of the MFC may occur.

The difference between the target flow and the actual flow of the MFC may result in an error in a gas mixing ratio.

### SUMMARY OF THE INVENTION

### Problems to be Solved by the Invention

Accordingly, it is an object of the present invention to provide a gas mixing controller and a method for controlling a mixing ratio in a gas mixing controller capable of preventing the occurrence of a mixing ratio error in a mixing gas caused by a flow error in an element gas by actively readjusting a target flow of the element gas.

### Means for Solving the Problems

In order to accomplish the above object, there is provided a method for controlling a mixing ratio in a gas mixing controller according to the present invention, including: (a) transmitting, by the gas mixing controller, respective target flow value determined based on target mixing ratios to a plurality of flow controllers which respectively control flows in a plurality of pipes; (b) receiving, by the gas mixing controller, respective actual flow values at each outlet of the plurality of pipes from the plurality of flow controllers; (c) modifying, by the gas mixing controller, a target flow value for the flow controller which controls flows in all pipes but a pipe in which a difference between the target flow value and the actual flow value is out of a predetermined error range among the plurality of pipes; and (d) transmitting, by the gas mixing controller, the modified target flow value to the flow controller which controls the flows in the all pipes but the pipe out of the predetermined error range.

Preferably, in the step (c), the target flow value for the flow controller which controls the flows in the all pipes but the pipe out of the predetermined error range is modified based on a ratio of the actual flow value to the target flow value in the pipe out of the predetermined error range.

In addition, according to the present invention, there is provided a gas mixing controller, including: a transmitting unit configured to transmit respective target flow value determined based on target mixing ratios to a plurality of flow controllers which respectively control flows in a plurality of pipes; a receiving unit configured to receive respective actual flow values at each outlet of the plurality of pipes from the plurality of flow controllers; and a control unit configured to modify a target flow value for the flow controller which controls flows in all pipes but a pipe in which a difference between the target flow value and the actual flow value is out of a predetermined error range among the plurality of pipes, wherein the transmitting unit transmits the modified target flow value to the flow controller which controls the flows in the all pipes but the pipe out of the predetermined error range.

Preferably, the control unit modifies the target flow value for the flow controller which controls the flows in the all pipes but the pipe out of the predetermined error range based on a ratio of the actual flow value to the target flow value in the pipe out of the predetermined error range.

### Advantageous Effects

According to the present invention, it is possible to prevent the occurrence of the mixing ratio error in the mixing gas caused by the flow error in the element gas by actively readjusting the target flow of the element gas.

In addition, according to the present invention, it is possible to prevent the facility failure and the safety accidents of industrial sites caused by the mixing ratio error and improve the quality of products using the mixing gas by preventing the mixing ratio error in the mixing gas from occurring.

Further, according to the present invention, it is possible to reduce the manpower for managing the facilities using the mixing gas.

### BRIEF DESCRIPTION OF THE DRAWINGS

FIG. 1 is a block diagram describing an operation principle of a gas mixing controller according to an embodiment of the present invention.

FIG. 2 is a block diagram illustrating a structure of the gas mixing controller according to the embodiment of the present invention.

FIG. 3 is a flow chart describing a procedure of a method for controlling a mixing ratio in the gas mixing controller according to the embodiment of the present invention.

### MODES FOR CARRYING OUT THE INVENTION

Hereinafter, present invention will be described in more detail with reference to the accompanying drawings. Referring to the drawings, wherein like reference characters designate like or corresponding parts throughout the several views. In the embodiments of the present invention, a detailed description of publicly known functions and configurations that are judged to be able to make the purport of the present invention unnecessarily obscure are omitted.

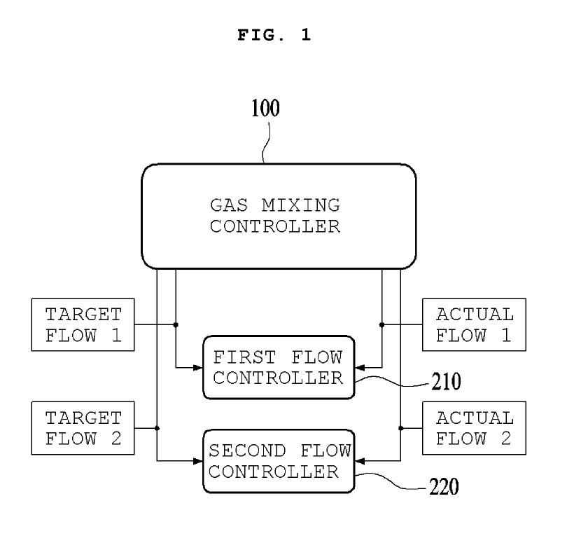

FIG. 1 is a block diagram describing an operation principle of a gas mixing controller according to an embodiment of the present invention. As illustrated in FIG. 1, a gas mixing controller 100 according to an embodiment of the present invention is configured to transmit respective target flow values determined based on target mixing ratios to a plurality of flow controllers 210 and 220 which respectively control flows in a plurality of pipes, and then respectively receive actual flow values at each outlet of the plurality of pipes from the plurality of flow controllers 210 and 220.

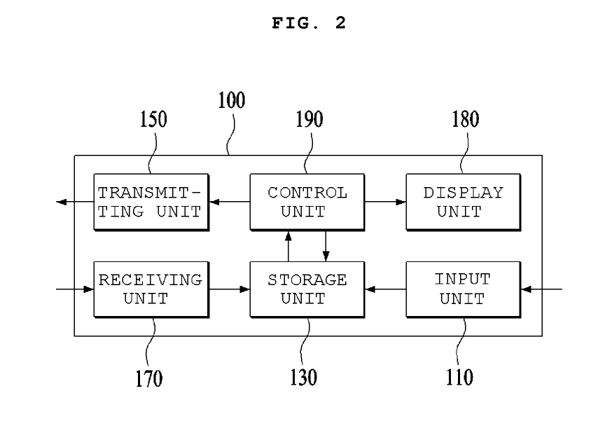

FIG. 2 is a block diagram illustrating a structure of the gas mixing controller 100 according to the embodiment of the present invention. Referring to FIG. 2, the gas mixing controller 100 according to the embodiment of the present invention includes an input unit 110, a storage unit 130, a transmitting unit 150, a receiving unit 170, a display unit 180, and a control unit 190.

First, a manager inputs a plurality of target mixing ratios of gas or respective target flow values in a plurality of pipes which is determined based on the plurality of target mixing ratios through the input unit 110 of the gas mixing controller 100, wherein the input target mixing ratios or the target flow values are stored in the storage unit 130.

Meanwhile, the transmitting unit 150 of the gas mixing controller 100 transmits the target flow values determined based on the target mixing ratios input by the manager or the target flow values individually input by the manager depending on the flow controllers to each flow controller, and then transmits the target flow values modified by the control unit 190 to each flow controller.

Meanwhile, the receiving unit 170 of the gas mixing controller 100 respectively receives actual flow values at each outlet of the plurality of pipes from the plurality of flow controllers 210 and 220. The control unit 190 modifies the target flow values for the flow controllers which controls the flows in all pipes but a pipe in which a difference between the target flow value and the actual flow value is out of a predetermined error range among the plurality of pipes, and the modified target flow values are stored in the storage unit 130.

Meanwhile, the display unit 180 of the gas mixing controller 100 serves to compare the target flow values for each pipe with the actual flow values at the outlets of each pipe which are received by the receiving unit 170 and display the compared result thereon to allow the manager to visually confirm the difference between the target flow values and the actual flow values for each pipe.

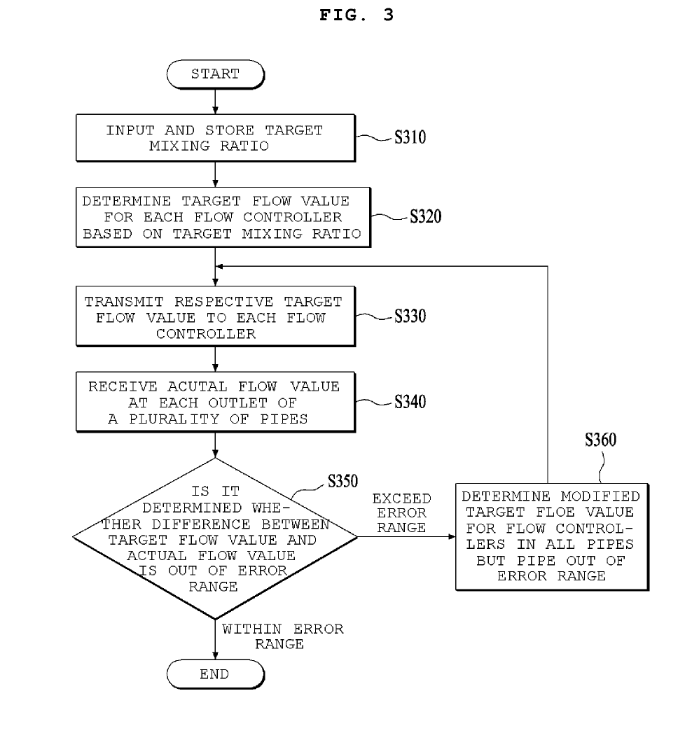

FIG. 3 is a flow chart describing a procedure of a method for controlling a mixing ratio in the gas mixing controller 100 according to the embodiment of the present invention. Hereinafter, the method for controlling a mixing ratio in the gas mixing controller 100 according to the embodiment of the present invention will be described with reference to FIGS. 1 to 3 and the following Table 1.

TABLE 1

| | | | | | | Target | Actual |
|---|---|---|---|---|---|---|---|
| | | Target | Actual | Target | Actual | Mixing | Mixing |
| No. | State | Flow 1 | Flow 1 | Flow 2 | Flow 2 | Ratio | Ratio |
| 1 | Normal | 1.0 SLM | 1.0 SLM | 1.0 SLM | 1.0 SLM | 50:50 | 50:50 |
| | State | | | | | | |
| 2 | Occurrence | 1.0 SLM | 1.0 SLM | 1.0 SLM | 0.5 SLM | 50:50 | 66:33 |
| | of Problem | | | | | | |
| | Situation | | | | | | |
| 3 | Mixing | 0.5 SLM | 0.5 SLM | 1.0 SLM | 0.5 SLM | 50:50 | 50:50 |
| | Ratio | | | | | | |
| | Control | | | | | | |
| 4 | Solution | 1.0 SLM | 1.0 SLM | 1.0 SLM | 1.0 SLM | 50:50 | 50:50 |
| | of Problem | | | | | | |
| | Situation | | | | | | |

First, the manager inputs 50:50 as a target mixing ratio in a first flow controller 210 and a second flow controller 220 through the input unit 110 of the gas mixing controller 100, and the target mixing ratio input by the manager is stored in the storage unit 130 (S310).

Meanwhile, the control unit 190 of the gas mixing controller 100 determines the respective target flow values in the first flow controller 210 and the second flow controller 220 to 1.0 SLM based on the target mixing ratios input by the manager, and the determined respective target flow values are also stored in the storage unit 130 of the gas mixing controller 100 (S320).

Next, the transmitting unit 150 of the gas mixing controller 100 transmits the respective target flow values determined for the first flow controller 210 and the second flow controller 220 to the first flow controller 210 and the second flow controller 220, respectively (S330).

Therefore, the first flow controller 210 and the second flow controller 220 respectively receive the target flow values from the gas mixing controller 100 and control the flows in the pipes managed by each of them based on the received target flow values.

Meanwhile, the first flow controller 210 and the second flow controller 220 measure the actual flow values at the outlets to the gas mixers managed by each of them, and the measured actual flow values are respectively transmitted to the gas mixing controller 100.

Therefore, the receiving unit 170 of the gas mixing controller 100 individually receives the actual flow values at the outlets of each pipe (S340), and the received actual flow values are stored in the storage unit 130, and then are displayed on the display unit 180 along with the target flow values.

Meanwhile, as shown in No. 1 of the above Table 1, when the control by each flow controller at each pipe is normally performed, the target flows and the actual flows in each pipe coincide with each other, and therefore the target mixing ratio and the actual mixing ratio coincide with each other.

However, as shown in No. 2 of the above Table 1, the target flow value in the second flow controller 220 is 1.0 SLM, while the actual flow value measured at the outlet of the pipe by the second flow controller 220 is 0.5 SLM, and thus, when a problem situation such as a case in which the actual mixing ratio becomes 66:33 occurs, the control unit 190 of the gas mixing controller 100 performs the following functions in order to solve the problem situation.

In this case, the control unit 190 of the gas mixing controller 100 determines whether the difference value between the target flow value and the actual flow value is out of the predetermined error range in the plurality of flow controllers 210 and 220, respectively (S350).

In detail, the control unit 190 of the gas mixing controller 100 determines whether the difference between the target flow value and the actual mass value exceeds 1% of the target flow value, and modifies the target flow value previously determined for all flow controller (first flow controller 210) but the flow controller (second flow controller 220 in the above Table 1) exceeding 1% of the target flow value based on a ratio of the actual flow value to the target flow value in the second flow controller 220 (S360).

That is, as shown in No. 2 of the above Table 1, the target flow value (1.0 SLM) and the actual flow value (0.5 SLM) in the second flow controller 220 have a ratio of 0.5, and therefore the control unit 190 modifies the target flow value at the first flow controller 210 from 1.0 SLM to 0.5 SLM as shown in No. 3 of the above Table 1.

The target flow value modified as described above is stored in the storage unit 130 of the gas mixing controller 100, and the transmitting unit 150 of the gas mixing controller 100 transmits the modified target flow value to the first flow controller 210 (S330).

Thereby, the first flow controller 210 receives the modified target flow value (0.5 SLM), and therefore the first flow controller 210 performs a control so that the flow at the outlet of the pipe is 0.5 SLM. Therefore, respective actual flow values in the first flow controller 210 and the second flow controller 220 form the same actual mixing ratio as the target mixing ratio.

As described above, the gas mixing controller 100 according to the embodiment of the present invention increases and decreases the flow values in all pipes but the pipe in which the problem occurs at the same ratio based on the increase and decrease ratio of the flow value in the pipe with the problem. Therefore, it is possible to actively satisfy the target mixing ratio of the mixing gas, even if a problem has occurred in a specific pipe.

Meanwhile, as shown in No. 4 of the above Table 1, when the problem in the second flow controller 220 is solved, the control unit 190 of the gas mixing controller 100 confirms that the difference value between the target flow value and the actual flow value in the second flow controller 220 are within the predetermined error range, such that the controller 190 recovers the target flow value modified in the above-described step S350 in the first flow controller 210 to the first determined target flow value in the above-described step S320, and transmits the recovered target flow value to the first flow controller 210.

While the present invention has been described with reference to the preferred embodiments, the present invention is not limited to the above-described embodiments, and it will be understood by those skilled in the art that various modifications and variations may be made therein without departing from the scope of the present invention as defined by the appended claims, and that various modifications should not be understood individually by those skilled in the art from the technical spirit or prospect of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

### INDUSTRIAL APPLICABILITY

The present invention may be applied to industrial fields related to a gas mixture, and therefore it has industrial applicability.

1. A method for controlling a mixing ratio in a gas mixing controller, comprising:
(a) transmitting, by the gas mixing controller, respective target flow value determined based on target mixing ratios to a plurality of flow controllers which respectively control flows in a plurality of pipes;
(b) receiving, by the gas mixing controller, respective actual flow values at each outlet of the plurality of pipes from the plurality of flow controllers;
(c) modifying, by the gas mixing controller, a target flow value for the flow controller which controls flows in all pipes but a pipe in which a difference between the target flow value and the actual flow value is out of a predetermined error range among the plurality of pipes; and
(d) transmitting, by the gas mixing controller, the modified target flow value to the flow controller which controls the flows in the all pipes but the pipe out of the predetermined error range.

2. The method of claim 1, wherein in the step (c), the target flow value for the flow controller which controls the flows in the all pipes but the pipe out of the predetermined error range is modified based on a ratio of the actual flow value to the target flow value in the pipe out of the predetermined error range.

3. A gas mixing controller, comprising:
a transmitting unit configured to transmit respective target flow value determined based on target mixing ratios to a plurality of flow controllers which respectively control flows in a plurality of pipes;
a receiving unit configured to receive respective actual flow values at each outlet of the plurality of pipes from the plurality of flow controllers; and
a control unit configured to modify a target flow value for the flow controller which controls flows in all pipes but a pipe in which a difference between the target flow value and the actual flow value is out of a predetermined error range among the plurality of pipes,
wherein the transmitting unit transmits the modified target flow value to the flow controller which controls the flows in the all pipes but the pipe out of the predetermined error range.

4. The method of claim 3, wherein the control unit modifies the target flow value for the flow controller which controls the flows in the all pipes but the pipe out of the predetermined error range based on a ratio of the actual flow value to the target flow value in the pipe out of the predetermined error range.
